(19) United States
(12) Patent Application Publication
(10) Pub. No.: US 2014/0282477 A1
(43) Pub. Date: Sep. 18, 2014

(54) AUTOMATIC UPDATING OF DATA IN APPLICATION PROGRAMS

(71) Applicant: 7LAYER TECHNOLOGIES, San Francisco, CA (US)

(72) Inventors: Shawn Modarresi, San Francisco, CA (US); Gordon Bentley, San Jose, CA (US)

(73) Assignee: 7Layer Technologies, San Francisco, CA (US)

(21) Appl. No.: 13/848,214

(22) Filed: Mar. 21, 2013

Related U.S. Application Data
(60) Provisional application No. 61/800,265, filed on Mar. 15, 2013.

(51) Int. Cl. G06F 9/445

(52) U.S. Cl. CPC G06F 8/65
USPC 717/171

(57) ABSTRACT

The present technology includes techniques to generate an application and to regenerate the application when updated content becomes available. While generating the application, a structured dataset can be created to store content for the application. The structured dataset can be manually or automatically edited to update the content. When the software provider is ready to update the application, the application can be regenerated in a single step of receiving the updated version of the structured dataset.

### CROSS-REFERENCE TO RELATED APPLICATIONS

This application claims the benefit of U.S. Provisional Patent Application No. 61/800,265, entitled “AUTOMATIC UPDATING OF DATA IN APPLICATION PROGRAMS”, filed on Mar. 15, 2013, and which is hereby expressly incorporated herein by reference in its entirety

### TECHNICAL FIELD

The present technology pertains to updating application programs, and more specifically pertains to techniques for generating an updated application by using a structured dataset.

### BACKGROUND

Traditionally, application programs are generated by a software provider and purchased by consumers from brick and mortar stores, an online retailer, or a software provider's website. Purchased applications are installed on the customer's device. As additional or updated information becomes available to the software provider, the application program can be updated. While very large applications in a desktop environment can be updated by a software update received from the software provider and integrated into the application program by a client device, this form of update is not available to mobile “apps” which require complete download and install of updated application in place of prior versions. The updated application is a completely regenerated application program to be provided to the customer via a download link or other means.

The frequency that updated applications are generated can depend on the importance and/or quantity of the updated information. For example, updated information for a video game application can be infrequent with a low priority and thus be batched into a quarterly software release. In contrast, updated information for a catalog application can have a higher priority since the price and availability of products presented in the application need to be updated in order to be presented to customers. If the application program requires regeneration to update the application, the application needs to be updated manually and the application needs to be recompiled. This process is both time consuming and requires much user interaction.

Surprisingly, even though some applications such as catalog applications require frequent updating, many catalog publishers are not interested in prior art solutions wherein updates are downloaded to a client device on an as available basis. Instead such catalog publishers require more control over the process, while still desiring speed and ease of updating. Such needs are not currently met by prior art systems and methods.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, devices, and non-transitory computer-readable storage media for generating an application and regenerating the application as new content becomes available. An application creation tool is described that is configured to generate an application based on user input and content received. In one example, a series of prompts can guide the application creation process by requesting input or content from the user to generate the application. The prompts can also present generic layouts that can be used to define the structure or application pages of the application. In some examples, a structured dataset file and an application definition file can be output after or during generation of the application. The structured dataset file can include information related to the content of the application while the application definition file can include information related to the structure and formatting of the application.

Besides generating the application, the application creation tool can also be configured to regenerate the application as new content becomes available. The process to regenerate the application can include receiving a structured dataset file. The structured dataset file can include the new content to be integrated into the updated application. In one example, the structured dataset can be an updated version of the structured dataset that is created during the initial generation of the application. Once the updated version of the structured dataset is received by the application creation tool, an application definition file can be retrieved. In one example, the application definition file can be retrieved based on metadata of the structured dataset. The application definition file can be retrieved according to the structured dataset that was received. Once the application creation tool has both the updated version of the structured dataset and the application definition file, an updated version of the application can be regenerated by the application creation tool. In some examples generating an updated version of the application can result in creating an updated version of the application definition file. If this happens, the updated version of the application definition file can overwrite an existing version stored in memory that belongs to or is accessible by the application creation tool.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary system configured to generate an application;

FIG. 2 illustrates an exemplary application page;

FIG. 3 illustrates an exemplary application definition file;

FIG. 4 illustrates an exemplary system configured to regenerate an application;

FIG. 5 illustrates an example of mapping values from a structured dataset to content items in an application page;

FIG. 6 illustrates an exemplary process for generating an application using an application creation tool;

FIG. 7 illustrates an exemplary process for regenerating an application;

FIG. 8 illustrates a conventional system bus computing system architecture; and

FIG. 9 illustrates a computer system having a chipset architecture that can be used in executing the described method and generating and displaying a graphical user interface (GUI).

### DESCRIPTION

Various embodiments of the technology are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for systems, devices, techniques, and methods for updating applications. An application can include content that is presented on multiple application pages. The structure of the application can dictate a navigation hierarchy, which defines the connectivity between application pages.

An application can be generated by utilizing an application creation tool. A software provider can provide user inputs and data to the application creation tool to generate an application. The user inputs can select one of many generic layouts to create an application page. The generic layouts can be stored in a database. Moreover, the user interface of the application can be specified through the user input. The user interface can include selecting the placement and inclusion of specific buttons to include in the application.

In one embodiment, the application creation tool can also output an application definition file that defines the structure of the application and a structured dataset containing the content of the application. When the content of the application changes due to updated information, an application provider can modify the structured dataset to reflect the updated information. The updated version of the structured dataset can be input into the application creation tool to generate an updated application. In one example, the application definition file can be provided to the application creation tool. In another example, the application definition file can be retrieved by the application creation tool from a database. The application creation tool can be utilized to create an application program and to provide a one step process for generating an updated application program for an application that was previously generated. The discussion below will begin with a discussion of the initial generation of the application, followed by a discussion of regeneration to create an updated application, and ending with exemplary systems and methods.

### Generating an Application

FIG. 1 illustrates an exemplary system configured to generate an application. System 100 includes application creation tool 100. Application creation tool 110 is configured to generate application program 150. In one example, application program 150 is a catalog application configured to present products on application pages. Each product can be presented on an application page of application program 150. Alternatively, multiple products can be presented on an application page of application program 150. The application creation tool 110 can reside on a server and communicate with clients to process application generation requests. In some embodiments, clients can communicate with the application tool via a web browser.

Application creation tool 110 receives user input 102 and data 104 for generating application 150. In some examples, application creation tool 110 can navigate the user through a series of prompts to create application 150. The series of prompts can request user input to specify the layout and appearance of application 150. In some examples, generic layouts stored in database 106 can be used to generate a page in the application (i.e., application page). The generic layout can specify the placement of generic content items on an application page. Database 106 can also include color schemes, navigation tools, and other tools that can be used to simplify the process of generating application 150.

The series of prompts can also request data to be populated into application 150. Data 104 can include content items that are assigned to generic content items in a generic layout of an application page. The content items can include a price, barcode, text, audio, video, images and other forms of content. In one example, the content items populating an application page can be associated with a single product for sale in a catalog. Application creation tool 110 can process user input 102, data 104, and database 106 to generate application 150. In one embodiment, application creation tool 110 can generate an application definition file 160 as an output file. The application definition file 160 can be configured to store information that defines the structure, navigation hierarchy, the layout for the application pages, and other non-content related information of application 150. In essence, the structure of application 150 can be regenerated based on the application definition file 160. Application creation tool 110 can further generate structured dataset 170 as an output file. Structured dataset 170 can be configured as a structured data structure capable of storing content related to application 150. In one example, structured dataset 170 can be a spreadsheet. In a catalog application, the rows of the spreadsheet are associated with different products while the columns of the spreadsheet are associated with content items (such as price, images, description, barcode, etc.) belonging to a given product. In some examples, each product can be presented on an application page of application 150.

FIG. 2 illustrates an exemplary application page. Application page 200 is generated by application creation tool 110 of FIG. 1 to be presented as part of an application. Application page 200 includes a plurality of content items. Content item 202, 204, 206, 208, and 210 can be positioned and oriented on application page 200 as shown in FIG. 2. The positioning and the orientation of the content items can be based on a generic layout that can be applied to some or all of the application pages of the application. In one example, a group of application pages belonging to a category of the application can have the same generic layout. Each content item in application page 200 can be configured to store information. The information can include text (such as a content item storing the title or description), an image (such as a barcode or images of product), or audio/video (such as a snippet describing a product).

FIG. 3 illustrates an exemplary application definition file. Application definition file 300 is configured to store non-content related information about the application. In one example, the application definition file 300 can be used to regenerate the application. For example, the application can be regenerated when changes to the content occur. Application definition file 300 can include application layout constraints 310. Application layout constraints 310 specify constraints and parameters that define the layout of the application. This can include the background color, logo, font, system requirements, button layout, menu options, etc. of the application.

Application definition file 300 can also include application page layout constraints 320. In contrast to application layout constraints 310 which define the layout of the application, application page layout constraints 320 define the layout of application pages within the application. For example, application page layout constraints 320 can define the page layout of each application page in the application. In some examples, the application page layout constraints 320 can define a page layout for application pages that belong to a category. The page layout of an application page can be a generic layout stored in a database, a modified version of a generic layout, or a unique layout specific to the application page.

Application definition rule 300 can further include application navigation constraints 330. Application navigation constraints 330 can specify the navigation hierarchy as the user navigates through application pages of the application. For example, application navigation constraints 330 can include information to link application pages to one another. This can dictate the order that application pages are presented to the user. Application pages can be viewed sequentially or alternatively can be linked via chapters or categories on a start screen. In one embodiment, application navigation constraints 330 can also define a navigation toolbar to navigate through the application. The navigation toolbar can include icons, which when selected, navigate to a particular application page. Application navigation constraints 330 can assign certain commands or icons of the navigation toolbar to gestures or hand swipes. When the gestures or hand swipes are performed on a user interface, the instruction associated with the command or icon can be executed. In yet other examples, other constraints 340 that are associated with the application can be stored in application definition file 300.

### Updating an Application

Once an application has been generated, the content within the application can be periodically updated. Updates to the content can result in regeneration of the application. In one embodiment, the application can be updated by using the application creation tool 110 discussed above in FIG. 1 to regenerate the application. A structured dataset outputted when the application was initially generated can be edited by a software publisher to update the content. For example, new products can be added to the structured dataset or changes to content items associated with a product can be modified within the structured dataset. The updated structured dataset can be received by the application creation tool to regenerate the application.

FIG. 4 illustrates an exemplary system configured to regenerate an application. System 400 includes application creation tool 110. Application creation tool 110 can be the same or substantially similar as application creation tool 110 of FIG. 1. Application creation tool 110 is configured to receive an updated structured dataset 410. Updated structured dataset 410 can include updated content for the application. In one embodiment, the updated content has been user defined by editing the structured dataset output when the application was previously generated. In another embodiment, the structured dataset can be created from scratch according to published specifications. Some exemplary formats suitable for a structured dataset include csv, xml, html, xls, etc.

Upon receiving updated structured dataset 410, application creation tool 110 retrieves an application definition file associated with the structured dataset. Together, the retrieved application definition file and the updated structured dataset 410 can be used to generate updated application 450. In one embodiment, updated structured dataset 410 can include identifier 412. Identifier 412 can be used by application creation tool 110 to locate the application definition file to be retrieved. In one example, the application definition file can be associated with the structured dataset 410 by matching identifier 412. Application creation tool 110 can retrieve the application definition file from memory or alternatively from database 106. Thus, an updated application can be regenerated from a single step of transmitting the updated structured dataset to the application creation tool. The application's non-content related information does not need to be entered again since the application creation tool can recreate non-content related information from the retrieved application definition file. This simplifies the process of regenerating the application to a single step.

Updated application 450 can include modified or additional application pages. The updated application retains the same appearance, structure, and navigation as the original application but contains modified content. In one example where the application is a catalog, updated application 450 can include updated information for products and/or additional products. Each of the additional products can be presented on a new application page. Alternatively, the additional products can be presented on an existing application page with other products.

In some examples, updated application definition 460 can be output from application creation tool 110. The updated application definition file can be generated when changes to the content of updated application 450 results in a change to the non-content properties of the application. For example, adding a new product into the structured dataset can result in a change to the pagination or navigation links of the application. As a result, updated application definition file 460 can be generated by application creation tool 110. The updated application definition file 460 can be stored in memory of application creation tool 110 or database 406 to be retrieved when regenerating the application to incorporate future updates.

FIG. 5 illustrates an example of mapping values from a structured dataset to content items in an application page. The mapping can occur while generating an updated application as described above in FIG. 4. FIG. 500 includes an exemplary structured dataset 510 and application page 550. Cells within structured dataset 510 are mapped to content items within application page 550. For example, cell 511 is mapped to content item 551, cell 513 is mapped to content item 553, cell 515 is mapped to content cell 555, cell 517 is mapped to content cell 557, and cell 519 is mapped to content cell 559. In some embodiments, a mapping table can be stored as metadata on structured dataset 510, on an application definition file, or on the application creation tool. The mapping table can map a cell within structured dataset to a content item in one of the application pages of the application. In some embodiments rather than mapping table, content placement rules can be defined, and such rules can be used to interpret a structured dataset and place content identified in the structured dataset in its appropriate place in the updated application.

In some instances, an image, video, or other media content can be assigned to a content item. The media item can be stored remotely with a link to the media item being stored within the cell of structured dataset 510. During mapping, the link can be followed to retrieve the media content for insertion into the appropriate content item. Here, the columns within structured dataset 510 are related to a product while the rows within structured dataset 510 relate to attributes of the product. The ordering of the columns within structured dataset 510 can affect the order of the application pages. In other examples, the opposite can occur, which is information assigned to a content item can be stored in structured dataset 510.

### Exemplary Systems and Methods

FIGS. 6-9 disclose exemplary methods that can be performed by an application creation tool and exemplary system embodiments of the application creation tool. FIG. 6 illustrates an exemplary process for generating an application using an application creation tool. Process 600 can begin after receiving a user request to generate an application. Process 600 begins by receiving user input at 610. The user input can be responses to prompts provided by the application creation tool. For example, a series of prompts can be provided to guide the user through the application creation process, which can include setting the background color, uploading a logo, selecting a platform, selecting the look and functionality of the navigation toolbar, and setting the navigation hierarchy of the application pages. While receiving user input, process 600 can also receive content at 620. Receiving content can include the user manually setting content items on application pages. For example, a user can assign an image to a content item belonging to an application page. In one embodiment, process 600 can dynamically build the structured dataset as an application page is generated and content is assigned to content items within the application page. Process 600 can retrieve information from a database at 630. Information from the database can include generic layouts for an application page or a generic structure for the application. The generic layouts or generic structure can serve as a template or starting point for the user to create the application.

Once the content and the user input have been received, process 600 can generate the application based on user input, received content, and the information from the database at 640. Known techniques for compiling and creating an application can be applied. During compilation or after generation of the application, an application definition file can be output at 650. The application definition file can contain non-content related information that can be used to regenerate the application at a later time. During compilation or after generation of the application, a structured dataset can also be output at 660. The structured dataset can include content related information that can be used to regenerate the application at a later time. In one embodiment, the structured dataset can be a spreadsheet containing cells, where cells of the spreadsheet are mapped to content items in the application. In some examples, a content item is configured to present media such as an image, video, or audio. The cell in the spreadsheet can store a link to retrieve the media. In one example, the media can be stored in a database accessible by the application creation tool, such as database 106 of FIG. 1. Once the application is generated and the application definition file or structured dataset is optionally outputted, process 600 ends.

FIG. 7 illustrates an exemplary process for regenerating an application. Process 700 can begin after receiving a user request to regenerate the application. It may be desirable to regenerate the application when new content becomes available, such as new products for sale or updates to product descriptions. Process 700 begins by receiving an updated version of the structured dataset at 710. The structured dataset can be generated from a previous process of the application creation tool that resulted in the generation of the application. Cells in the updated version of the structured dataset can include updated values. Additionally, the updated version can also include new cells. Some or all of the updates to the structured dataset can be manually entered. Alternatively, some or all of the updates to the structured dataset can be automatically entered into the structured dataset using a script. In some embodiments, the structured dataset is created from scratch according to predefined specifications.

In one embodiment, after receiving the updated version of the structured dataset, process 700 can retrieve an application definition file at 720. The application definition file can be retrieved according to the updated version of the structured dataset that was received. In one example, the structured dataset can include an identifier that allows process 700 to match the structured dataset to a matching application definition file. The application definition file can be retrieved from a database. In one example, the application being regenerated was originally generated using the same application creation tool. The application definition file that was previously generated along with the application can be utilized to regenerate the application. The application definition file can have been saved on a database accessible to the application creation tool. In other embodiments, the application definition file can be retrieved before the updated version of the structured dataset.

In some embodiments the application definition file is provided to the application creation tool along with, or in separate steps from providing the structured dataset. In some embodiments, a user directs the application creation tool to retrieve the application definition file by navigating a file directory or selecting the application definition file from a list of files associated with a user profile. In other examples, the application definition file can include a link to a predetermined location storing the structured dataset. When the application definition file is selected, the application creation tool can automatically retrieve the version of the structured dataset from the predetermined location.

After receiving the updated version of the structured dataset and the application definition file, an updated application can be generated at 730. The updated application can be generated based on the updated version of the structured dataset along with the application definition file. The updated application can retain the same formatting and structure as the non-updated application but contain additional or modified content. Process 730 can output updated application definition file at 740.

As used herein, the term or concept of updating an application in single step or automatically refers to the method illustrated in FIG. 7, wherein an updated application is output by the application creation tool from the input of the structured dataset and application definition file. It is not relevant how the application creation tool receives or retrieves the structured dataset and application definition file, rather what is relevant is that the application creation tool can generate an updated application automatically from the single step of providing the two input files and initiating the process.

The updated application definition file can be generated when additional application pages are added to the application. The additional pages can change the parameters of the application such as total number of pages or the pagination of the application pages. As a result, an updated application definition file can be output. The updated application definition file can be stored in a database. In some examples, the updated application definition file can overwrite the previous application definition file.

FIG. 8 and FIG. 9 illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 8 illustrates a conventional system bus computing system architecture 800 wherein the components of the system are in electrical communication with each other using a bus 805. Exemplary system 800 includes a processing unit (CPU or processor) 810 and a system bus 805 that couples various system components including the system memory 815, such as read only memory (ROM) 820 and random access memory (RAM) 825, to the processor 810. The system 800 can include a cache of high-speed memory connected directly with, in close proximity to, or integrated as part of the processor 810. The system 800 can copy data from the memory 815 and/or the storage device 830 to the cache 812 for quick access by the processor 810. In this way, the cache can provide a performance boost that avoids processor 810 delays while waiting for data. These and other modules can control or be configured to control the processor 810 to perform various actions. Other system memory 815 may be available for use as well. The memory 815 can include multiple different types of memory with different performance characteristics. The processor 810 can include any general purpose processor and a hardware module or software module, such as module 1 832, module 2 834, and module 3 836 stored in storage device 830, configured to control the processor 810 as well as a special-purpose processor where software instructions are incorporated into the actual processor design. The processor 810 may essentially be a completely self-contained computing system, containing multiple cores or processors, a bus, memory controller, cache, etc. A multi-core processor may be symmetric or asymmetric.

To enable user interaction with the computing device 800, an input device 845 can represent any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art. In some instances, multimodal systems can enable a user to provide multiple types of input to communicate with the computing device 800. The communications interface 840 can generally govern and manage the user input and system output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof.

The storage device 830 can include software modules 832, 834, 836 for controlling the processor 810. Other hardware or software modules are contemplated. The storage device 830 can be connected to the system bus 805. In one aspect, a hardware module that performs a particular function can include the software component stored in a computer-readable medium in connection with the necessary hardware components, such as the processor 810, bus 805, display 835, and so forth, to carry out the function.

FIG. 9 illustrates a computer system 900 having a chipset architecture that can be used in executing the described method and generating and displaying a graphical user interface (GUI). Computer system 900 is an example of computer hardware, software, and firmware that can be used to implement the disclosed technology. System 900 can include a processor 955, representative of any number of physically and/or logically distinct resources capable of executing software, firmware, and hardware configured to perform identified computations. Processor 955 can communicate with a chipset 960 that can control input to and output from processor 955. In this example, chipset 960 outputs information to output 965, such as a display, and can read and write information to storage device 970, which can include magnetic media, and solid state media, for example. Chipset 960 can also read data from and write data to RAM 975. A bridge 980 for interfacing with a variety of user interface components 985 can be provided for interfacing with chipset 960. Such user interface components 985 can include a keyboard, a microphone, touch detection and processing circuitry, a pointing device, such as a mouse, and so on. In general, inputs to system 950 can come from any of a variety of sources, machine generated and/or human generated.

Chipset 960 can also interface with one or more communication interfaces 990 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 955 analyzing data stored in storage 970 or 975. Further, the machine can receive inputs from a user via user interface components 985 and execute appropriate functions, such as browsing functions by interpreting these inputs using processor 955.

It can be appreciated that exemplary systems 800 and 900 can have more than one processor or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer-implemented method comprising:
receiving, by a server:
an application identifier identifying an original application, and
an updated dataset, the updated dataset including an updated content item value that maps to a first content item presented by the original application identified by the application identifier, wherein the original application is presenting the first content item according to an original content item value included in an original dataset;
retrieving, by the server, an application definition file defining the structure of the original application identified by the application identifier, the application definition file including application layout constraints defining a layout of the first content item by the original application; and
automatically updating, by the server, the original application by generating an updated application according to the updated dataset and the application layout constraints included in the application definition file, whereby the updated application presents the first content item according to the updated content item value included in the updated dataset.

2. A product comprising:
a non-transitory machine readable storage medium; and
a machine executable instruction stored on the non-transitory computer readable storage medium, the machine executable instruction, which when executed by a machine, configured to causes the machine to perform a method, the method comprising:
receiving:
an application identifier identifying an original application, and
an updated dataset, the updated dataset including an updated content item value that maps to a first content item presented by the original application identified by the application identifier, wherein the original application is presenting the first content item according to an original content item value included in an original dataset;
retrieving an application definition file defining the structure of the original application identified by the application identifier, the application definition file including application layout constraints defining a layout of the first content item by the original application; and
automatically updating the original application by generating an updated application according to the updated dataset and the application layout constraints included in the application definition file, whereby the updated application presents the first content item according to the updated content item value included in the updated dataset.

3. A system comprising:
a processor; and
a memory configured to store instructions for controlling the processor to perform steps comprising:
receiving:
an application identifier identifying an original application, and
an updated dataset, the updated dataset including an updated content item value that maps to a first content item presented by the original application identified by the application identifier, wherein the original application is presenting the first content item according to an original content item value included in an original dataset;
retrieving an application definition file defining the structure of the original application identified by the application identifier, the application definition file including application layout constraints defining a layout of the first content item by the original application; and
automatically updating the original application by generating an updated application according to the updated dataset and the application layout constraints included in the application definition file, whereby the updated application presents the first content item according to the updated content item value included in the updated dataset.
